(19) United States
(12) Patent Application Publication
(10) Pub. No.: US 2011/0035872 A1
(43) Pub. Date: Feb. 17, 2011

(54) METHOD AND SYSTEM FOR ATTACHING AN INSERT ONTO AN EXISTING BATHTUB AND SHOWER ENCLOSURE

(76) Inventor: Scott Hasselbring, Miami, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/540,795

(22) Filed: Aug. 13, 2009

(51) Int. Cl. A47K 3/02; B23P 6/00

(52) U.S. Cl. 4/580; 4/612; 29/402.01

(57) ABSTRACT

The invention is directed towards refurbishing an existing bathtub, which comprises an insert of sufficient size and dimension so as to mirror the contours, recess and essentially flat upper portion of the existing bathtub. Placed on top of the existing bathtub is a three-piece constructed frame that includes (a) an essentially flat primer sheet affixed directly to the upper flat portion of the existing bathtub, (b) a gasket having an essentially flat horizontal portion affixed to the primer sheet, and (c) at least one strip of adhesive tape affixed to the gasket and a concentration of liquid based sealant placed at each of the adjoining corners of the three-piece constructed frame. The related method includes affixing strips of primer sheet on the existing bathtub, securing a gasket on the primer sheet, attaching a strip of adhesive tape onto the gasket, and placing a concentration of sealant at each adjoining corner.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates to a method and system for affixing an insert onto an existing bathtub and shower enclosure.

### BACKGROUND OF THE INVENTION

The home improvement and refurbishment industry has steadily grown in size and importance over the past decade. Today, the home improvement industry is a $300 billion per year business category. On average, a home improvement project costs approximately $3,000. Apart from the kitchen, the bathroom is the most commonly remodeled room when performing a home improvement project. The cost of a bathroom remodel typically ranges between $5,000 to as much as $30,000.

There exist numerous reasons for renovating an existing residential bathroom. First, a homeowner desiring to sell an older home may want to update a dated bathroom to improve marketability of the home. This is true for not only a down housing market (where there is significant inventory of homes on the market) but also when there is a housing boom (to get top dollar for the house). Second, a recent purchaser of an older home often desires to update a bathroom to conform with his or her particular taste and style. Third, a homeowner living in an area having large concentrations of minerals in the water supply may want to replace the existing bathtub and/or shower enclosure due to staining and discoloration caused by mineral build-up. Finally, humid climates often can cause unsavory mildew stains in the grout and/or corners in well-used bathtubs and shower enclosures.

Regardless of the underlying reason for a bathroom remodel, the most expensive component of the renovation is the removal and replacement of the existing bathtub and shower enclosure. The reason typically stems from the way bathrooms are constructed, as the bathtub and shower enclosure are usually the initial component(s) placed in the room prior to other adjacent components—such as the tile, vanity, sink and cabinets. Because of this, it is necessary to remove all or some of these secondary components when replacing a bathtub or shower enclosure. Often such replacement requires drywall patchwork or partial retiling of the area around the bathtub or shower enclosure.

Due to the aforementioned complexity of traditional bathroom remodeling and associated costs, homeowners have recently looked for less expensive options. One popular option is the use of inserts, which have approximately the same size and dimension of existing bathtubs and shower enclosures. Inserts are prefabricated and engineered to fit the specific contours of commercially available bathtubs and shower inserts.

Apart from selecting an insert and cutting the various panels for the shower enclosure, the key consideration when performing a bathroom remodel is creating an effective non-permeable watertight seal between the existing bathtub and shower enclosure and the insert(s). If this configuration of the seal is ineffective or shoddy, the gap between the existing bathtub and shower enclosure can fill with water over a period of use. This can cause the insert to swell or even detach. Mold and build-up of bacteria can also result, causing a health concern. The same holds true if the sealants used to create the seal are susceptible to degradation after significant use.

Currently, there exist only a few rudimentary configurations to affix an insert onto an existing bathtub or shower, none of which have proven effective or fail-safe. Most use flat butylene tape affixed to the bottom side of the insert prior to placement onto the existing bathtub or shower enclosures. Other configurations include parallel baffles along the horizontal plane of the existing bathtub and shower enclosure prior to affixing the insert. Both of the aforementioned configurations require excessive use of butylene tape, which requires added cost and instillation time.

There exists a need in the art of bathroom remodeling for an effective method and system for affixing an insert onto an existing bathtub and shower enclosure. More specifically, there is a need for an improved configuration to create a non-permeable and watertight seal when installing a bathtub or shower enclosure insert to prevent unwanted entry of water in the gap between the existing bathtub and shower enclosure and the insert. Finally, there exists a need for a new combination and selection of effective sealants to achieve the seal.

### SUMMARY OF THE INVENTION

The instant invention solves the current limitations found in the art of affixing an insert onto an existing bathtub and shower enclosure during a bathroom refurbishment project. Both the method and resulting system employ a specific combination and arrangement of sealants to create a non-permeable and durable seal, without wasting costly materials as well as reducing installation time.

The preferred system of refurbishing an existing bathtub starts with an insert of sufficient size and dimension so as to mirror the contours, recess and essentially flat upper portion of the existing bathtub. Placed on the essentially flat upper portion of the existing bathtub is a three-piece constructed frame, which includes (a) an essentially flat primer, (b) a gasket having an essentially flat portion affixed to the primer sheet, and (c) at least one strip of butyl tape affixed to the gasket. In addition, a concentration of liquid based sealant—preferably silicone—is placed at each of the adjoining corners of the three-piece constructed frame.

The gasket of the preferred system can take many forms, including an essentially “L” shaped gasket through attaching a vertical portion perpendicular to the essentially flat horizontal portion. As an alternative embodiment, the gasket can be essentially “U” shaped through attaching a second vertical portion in parallel with the first vertical portion—both of which are perpendicular to the essentially flat horizontal portion. Each gasket, regardless of configuration, is preferably made of synthetic rubber. In addition, the butyl tape affixed to the gasket is preferably circular in cross section and manufactured from ADCO Formula #BX-305.

The invention is further directed to a system for refurbishing a shower enclosure. This system starts with an existing shower enclosure having an upper edge, a lower edge, a right side edge and a left side edge, and essentially flat panels having a dimension which mirrors each side of the existing shower enclosure. The system also includes an outside frame constructed approximately one inch from the upper edge, lower edge, right side edge and left side edge of the existing shower enclosure. This outside frame includes a plurality of strips of butyl tape essentially circular in cross section affixed to the existing shower enclosure and a concentration of liquid based sealant (again preferably silicone) placed at each adjoining corner of the outside frame.

The invention also addresses the scenario where the existing shower enclosure includes an existing window having an upper edge, a lower edge, a right side edge and a left side edge. The system contemplates an inside frame (in addition to the outside frame) constructed proximate to each of the four edges of the existing window. This inside frame includes a plurality of strips of butyl tape essentially circular in cross section affixed to the existing shower enclosure and a concentration of liquid based sealant—again preferably silicone, at each of the adjoining corners of the inside frame.

In addition to the aforementioned systems, the invention is further directed toward a preferred method of affixing an insert to an existing bathtub. This system first includes the step of affixing a strip of flat primer sheet directly on the back side, front side, left side and right side of the upper flat portion of the existing bathtub as the foundation of a frame. Second, the method contemplates securing a gasket, having an essentially flat horizontal portion, on each strip of primer sheet in order to add a second layer to the frame. A strip of butyl tape is then attached onto the essentially flat horizontal portion of each gasket to create a third layer to the frame. Next, a concentration of liquid based sealant—preferably silicone—is placed at each adjoining corner of the three-layer frame.

Once this three-layer frame is created, the system contemplates positioning the insert on top of the existing bathtub and then securing the insert to create a non-permeable and durable seal.

### BRIEF DESCRIPTION OF THE DRAWINGS

FIG. 1 is a perspective view of the shape and orientation of a standard insert to place over an existing bathtub, including a hole to allow access to the existing drain.

FIG. 2A is a perspective view of one preferred configuration of sealants around an existing bathtub, through combination of a primer sheet, an “L” shaped synthetic rubber gasket, and a concentration of silicone sealant.

FIG. 2B is a perspective view of a second preferred configuration of sealants around an existing bathtub, through combination of a primer sheet, an “U” shaped synthetic rubber gasket, and a concentration of silicone sealant.

FIG. 3 is a top view of the second preferred configuration of sealants which further shows placement of silicone sealant at the adjoining corners created through adjoining two “U” shaped gaskets of synthetic rubber.

FIG. 4 is a front view of one side of a shower enclosure, including framing of butyl tape around the four outside edges of an existing window.

FIG. 5 is a front view of an existing bathtub and shower enclosure framed through placement of butyl tape to create a seal around a shower head, bathtub filler and valves.

FIG. 6 is a perspective view of an essentially “L” shaped gasket in which an essentially round portion of butylene tape is placed.

FIG. 7 is a front view of placement of a concentration of liquid silicone sealant at the corner of essentially rectangular framing created by two portions of essentially flat butyl tape.

### DETAILED DESCRIPTION OF THE INVENTION

The present invention will now be described more fully hereinafter with reference to the accompanying figures, in which preferred embodiments of the system and method for affixing an insert to an existing bathtub or shower enclosure are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art.

### The Preferred System of Affixing the Insert

The preferred system includes a bathtub insert 100, the existing bathtub 200 to be refurbished, and panels 300 to be cut and arranged to fit into the existing shower enclosure 400. Placed in between the existing bathtub 200 and shower enclosure 400 and the insert 100 and panels 300 is a specific combination and unique configuration of sealants 500. Although the specific combination of sealants 500 may differ, the invention teaches use of three-piece construction which includes a primer sheet 510 placed onto the existing bathtub 200, a gasket 520 and butyl tape 530. Preferred combinations and configurations of sealants 500 are discussed in greater detail below.

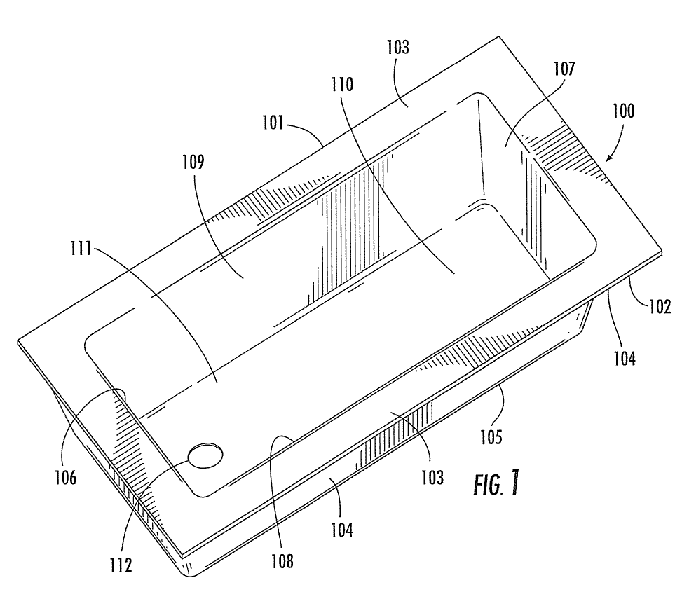

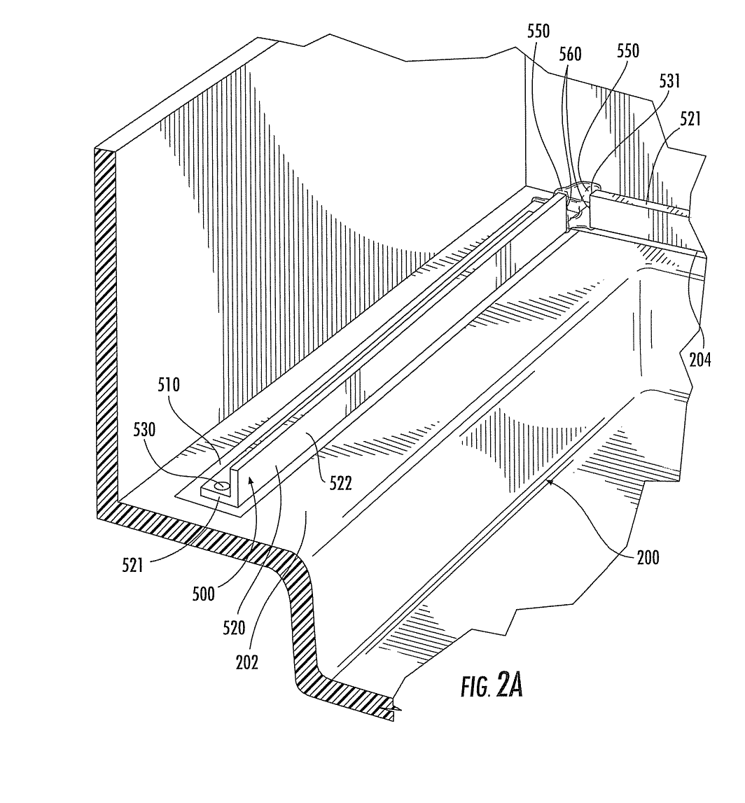

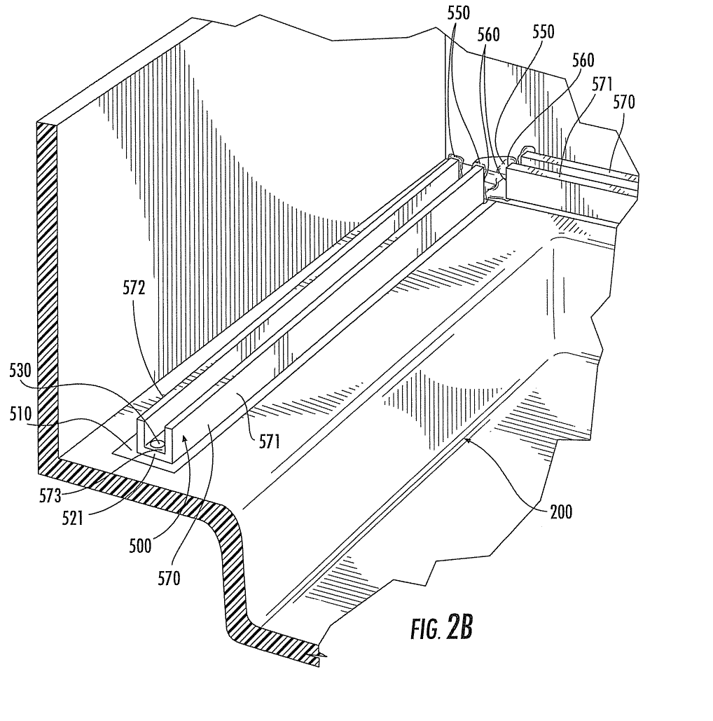

The first component of the preferred system is the insert 100 illustrated in FIG. 1. The insert 100 comprises an essentially flat top lip 101 and bottom base 102 attached below the top lip 101. The top lip 101 of the insert 100 has a flat top side 103 and a corresponding flat bottom side 104. The bottom base 102 includes an outer portion 105 whose shape mirrors the contours, shape and dimension of the exterior of the existing bathtub 200 (illustrated below in FIG. 2a and FIG. 3). Opposite the outer portion 105 is the front interior side wall 106 and back interior side wall 107. Positioned between both the front 106 and back interior side walls 107 are the left interior side wall 108 and right interior side wall 109 of the insert 100.

At the distal end of the four side walls 106-109 is a bottom panel 110. The four side walls 106-109 and bottom panel 110 form the recess 111 of the insert 100. The recess 111 includes a circular hole 112 which is the same diameter as the existing drain 113 (illustrated in FIG. 3) of the existing bathtub 200. While the insert 100 can be manufactured from any durable and waterproof material, it is preferably made of co-extrusion composite such as acrylic. The acrylic should include a smooth exterior surface on both the side walls 106-109 and the bottom panel 110.

### First Embodiment of Sealants

FIGS. 2A and 2B illustrate two examples of the preferred configuration of sealants 500 placed on the existing bathtub 200 prior to affixing the insert 100 shown in FIG. 1. First turning to FIG. 2A, this configuration shows one way to employ three-part construction of sealants 500 to effectuate a non-permeable watertight seal. The foundation of the seal begins with a primer sheet 510 affixed directly to the existing bathtub 200. The primer sheet 510 is a thin, essentially flat (and rectangular) strip which mirrors either the length or width of the existing bathtub 200. It is preferable (but not necessary) that the primer sheet 510 be manufactured from Polyken 1027.

As further shown in FIG. 2A, affixed on top of the primer sheet 510 is a gasket 520. The gasket 520 can be shaped and formed into a variety of arrangements to help effectuate a seal between the existing bathtub 200 and the insert 100. In this embodiment, the gasket 520 is an essentially “L” shaped strip preferably made of synthetic rubber. More specifically, the “L” shaped gasket 520 comprises a horizontal portion 521, as well as a right vertical portion 522 perpendicular to the horizontal portion 521. The “L” shaped gasket 520 can be made of a variety of materials, including butylene, synthetic rubber, or similar material known to one of ordinary skill in the art. Placed on the horizontal portion 521 (and adjacent to the right vertical portion 522) is a strip of butly tape 530. While the shape and arrangement can differ, it is preferred the butyl tape 530 is essentially circular in cross-section. More specifically, the butyl tape 530 should be ½″ by ⅛″ butyl tape (ADCO Formula #BX-035).

Through combination of the “L” shaped gasket 520 and the essentially circular strip of butyl tape 530, this three-part construction creates two separate sealing points 531 between the insert 100 and existing bathtub 200. More importantly, each sealing point 531 is preferably of different material (synthetic rubber and butylene). This configuration and use of multiple materials ensures not only a water-tight seal, but also a seal which will not degrade over time.

In addition to use of multiple potential sealing points 531, the embodiment shown in FIG. 2A further illustrates use of a third material to help effectuate a non-permeable seal. More specifically, a concentration of liquid based sealant 550 is placed in the adjoining corners 560 created through placing the “L” shaped gasket 520 positioned along the length of the existing bathtub 200 and proximate to the “L” shaped gasket 520 allocated along the width of the existing bath tub 200. This liquid based sealant 550 is preferably a silicone based sealant whose composition is organopolysiloxane. However, any similar liquid based sealant 550 known to those of ordinary skill in the art can be used. The purpose of such liquid based sealant 550 is to ensure the adjoining corners 560 do not create a potential breach in the effective two-part seal created through combined use of the “L” shaped gasket 520 and the essentially circular strip of butyl tape 530.

### Second Embodiment of Sealants

FIG. 2B illustrates a second preferred configuration for the sealants 500. As with the configuration shown in FIG. 2A, the foundation again begins with a thin strip of essentially flat (and rectangular) primer sheet 510 which mirrors either the length or width of the existing bathtub 200. The primer sheet 510 can be made of a variety of materials known to those of ordinary skill in the art, but preferably made of Polyken 1027.

Affixed to the foundation created through the primer sheet 510 is an essentially “U” shaped gasket 570. The “U” shaped gasket 570 is preferably made of either butylene or synthetic rubber, but can be manufactured from any similar based material known to those of ordinary skill in the art. The “U” shaped gasket 570 includes an essentially flat horizontal portion 521. In addition, a pair of vertical portions 571 and 572 are attached on top of (and perpendicular to) the essentially flat horizontal portion 521—all of which together comprise the “U” shaped gasket 570. Both vertical portions 571 and 572 are preferably the same height and are arranged parallel to one another. However, in some arrangements of the “U” shaped gasket 570 it may be preferable that the vertical portions 571 and 572 are of different heights.

Through parallel arrangement of both vertical portions 571 and 572, there is a conduit 573 created within the “U” shaped gasket 560. Preferably placed within this conduit 573 is a strip of butyl tape 530. However, other sealing materials (including but not limited to a liquid sealant 550 like silicone) can be placed within the conduit 573. While the shape and arrangement can differ, it is preferred the butyl tape 530 is essentially circular in cross-section. Unlike the “L” shaped gasket 520 taught in FIG. 2A, the “U” shaped gasket 570 shown in FIG. 2B creates three separate sealing points 531 between the insert 100 and the existing bathtub 200. These three sealing points 531 are preferably made of at least two different materials (synthetic rubber and butylene) to offer a more resilient and long lasting seal.

Just as in FIG. 2A, the second embodiment illustrated in FIG. 2B includes use of a third material to help effectuate a non-permeable seal. FIG. 3 shows placement of liquid based sealant 550 within the adjoining corners 560 of two adjoining “U” shaped gaskets 570. The liquid based sealant 550 is preferably organopolysiloxane, a type of commercially available silicone sealant. However, any similar liquid based sealant 550 known to those of ordinary skill in the art can be used. Regardless of material, the liquid based sealant 550 ensures the adjoining corners 560 do not create a potential leakage point between the ends of two “U” shaped gaskets 570—when the insert 100 is placed on top of the existing bathtub 200 such that the bottom side 104 of the top lip 101 contacts both the “U” shaped gaskets 570 and the essentially circular butyl tape 530.

FIG. 3 further shows the placement and location of the existing drain 113 located within the existing bathtub 200. As previously discussed, a circular hole 112 of the same diameter as the existing drain 113 is positioned and bore through the insert 100. Thus, this circular hole 112 will align with the existing drain 113 when the insert 110 is positioned and secured to the existing bathtub 100 through use of either the “L” shaped gasket 520 or “U” shaped gasket 570 arrangements previously discussed. Proximate to the opening of the existing drain 113 are a plurality of small strips of butyl tape 410 placed in an essentially circular orientation. Such strips mirror the shape and size of the opening of the existing drain 113 on the existing bathtub 200 to effectuate an efficient seal.

### The Preferred System of Affixing the Panels and Windows

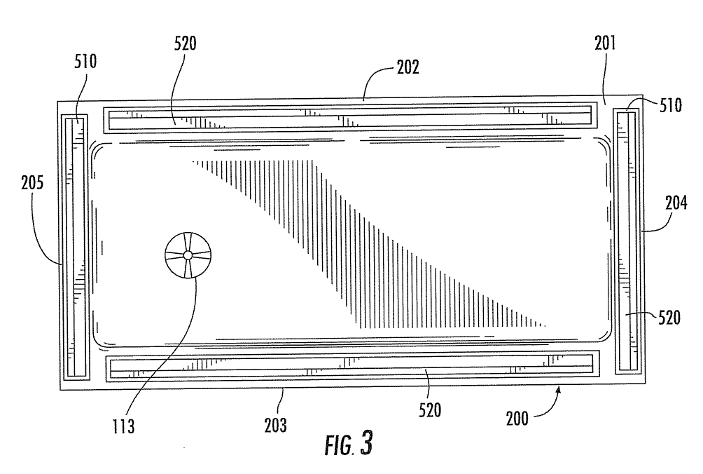

In addition to the system for affixing the insert 100 onto the existing bathtub 200, the instant invention is further directed to a system for affixing multiple panels 300 onto an existing shower enclosure 400. As illustrated in FIG. 4, the typical shower enclosure includes three side walls located above the existing bathtub 200 which acts as the basin for the shower enclosure 300. Often as is shown in FIG. 4, there is a window 450 located within one side wall of the shower enclosure. A cut-out 350 within the panel 300 is created, whose size and dimensions mirror the outer edges of the existing window 450. However, the area between the edge of the cut-out 350 and the outer edges of the existing window 450 is often a source of leakage when a panel 300 is placed into the existing shower enclosure 400.

The instant invention reduces the risk of leakage between the cut-out 350 and window 450. As shown in FIG. 4, framing and positioning of multiple strips of butyl tape 410 in close proximity to the outer edges of the window 450 can reduce the chances of leakage. Such framing should preferably include butyl tape 410 which is essentially circular in cross-section. More specifically, the butyl tape 410 should be ½″ by ⅛″ butyl tape (ADCO Formula #BX-035). An optional (but not required) thin and rectangular strip of primer sheet 405 can be placed between the existing shower enclosure 400 and the butylene tape 410 when creating this framing. It is preferable (but not necessary) that the primer sheet 510 be manufactured from Polyken 1027.

More specifically, when framing to reduce the risk of later leakage, it is important to place strips of butyl tape 410 approximately one inch from the outer edge of the existing window 450. There should be at least four strips of butyl tape 410 approximately one inch from each of the four outer edges—two vertical strips 411 and 412 and two horizontal strips 413 and 414. It is preferable that the two vertical strips 411 and 412 of butyl tape 410 be longer than the height of the outer edge of the existing window 450 such that they end proximate to the upper edge of the existing bathtub 200. Accordingly, both vertical strips 411 and 412 help secure the panel 400 onto the middle portion of one side of the shower enclosure 300.

As with the aforementioned embodiments for affixing the insert 100 onto the existing bathtub 200, FIG. 4 also shows placement of liquid sealant 550 within the adjoining corners 560 of two adjoining strips of butyl tape 410 when creating a seal between the existing shower enclosure 400 and the panel 300. The liquid based sealant 550 is preferably organopolysiloxane, a type of commercially available silicone sealant. However, any similar liquid based sealant 550 known to those of ordinary skill in the art can be used. Placement of this liquid sealant 550 at the adjoining corners 560 helps prevent breach of the seal created through use and placement of butyl tape 410 within one inch of the exterior edges of the existing window 450.

In addition to framing around the edges of an existing window 450, the invention further teaches use of framing near the end edges 460 of a side of the existing shower enclosure 400. As illustrated in FIG. 4, this includes placement of long strips of butyl tape 510 approximately one inch from the end edges 460 of a side of the existing shower enclosure 400. An optional (but not required) thin and rectangular strip of primer sheet 405 can be placed between the existing shower enclosure 400 and the butylene tape 410 when creating this framing. It is preferable (but not necessary) that the primer sheet 510 be manufactured from Polyken 1027.

As with the aforementioned framing around an existing window 450, liquid sealant 550 should be placed within the adjoining corners 560 of two adjoining strips of butyl tape 410—as shown in FIG. 4. The liquid based sealant 550 is preferably organopolysiloxane, a type of commercially available silicone sealant. However, any similar liquid based sealant 550 known to those of ordinary skill in the art can be used. A larger concentration of liquid based sealant 550 should be placed between the existing bathtub 200 and the two horizontal strips 415 and 416 of butyl tape 410 to ensure an effective seal between the panel 300 and insert 100.

### System for Sealing Around Bathtub Fillers and Showerheads

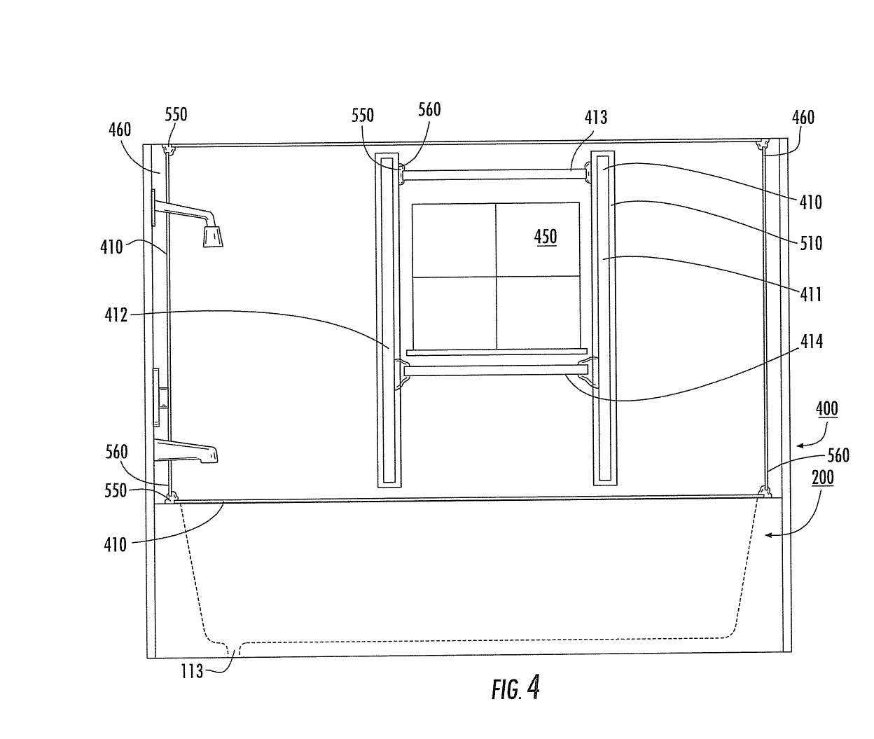

The present invention is also directed towards a preferred system of creating effective seals around existing bathtub fillers 470, shower head 480 and related valves 490. As shown in FIG. 5, the sealing of these various protrusions (470, 480 and 490) starts with two long vertical strips 471 and 472 proximate to the outside edges of the bathtub fillers 470, shower heads 480 and related valves 490. These two vertical strips 471 and 472 run approximately from the top of the shower enclosure 400 to the top of the existing bathtub 200.

Both strips 471 and 472 are preferably butyl tape 410 essentially circular in cross-section. More specifically, the butylene tape 410 should be ½″ by ⅛″ butyl tape (ADCO Formula #BX-035). An optional (but not required) thin and rectangular strip of primer sheet 510 can be placed between the existing shower enclosure 400 and the butylene tape 410 when creating this framing. It is preferable (but not necessary) that the primer sheet 510 be manufactured from Polyken 1027.

In addition to both vertical strips 471 and 472, it is preferable to placed multiple horizontal strips (473 through 478) proximate to the upper and lower sides of the bathtub filler 470, shower head 480 and related valves 490. More specifically, a first set of two horizontal strips 473 and 474 are placed one inch above and below the shower head 480. In addition, a second set of two horizontal strips 475 and 476 are placed one inch above and below the valves 490. Finally, a third set of two horizontal strips 477 and 478 are placed one inch above and below the bathtub filler 470.

Liquid based sealant 550 is placed at the adjoining corners 560 of strips 471-478 as shown in FIG. 5. The liquid based sealant 550 is preferably organopolysiloxane. However, any similar liquid based sealant 550 known to those of ordinary skill in the art can be used. Through these three sets of horizontal strips (473 through 478) and placement of liquid sealant 550, an effective seal is created between these various protrusions (470, 480 and 490) and the panel 300.

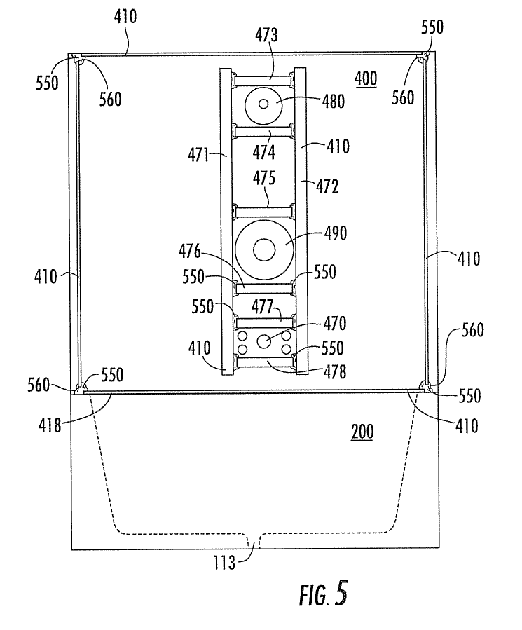

FIG. 6 offers a perspective view of the “L” shaped gasket 520 preferably made of synthetic rubber also shown in FIG. 2A. The benefit of this configuration is that the essentially flat horizontal portion 521 provides a cradle to position a secondary adhesive such as a strip of butyl tape 530, essentially circular in cross section—in addition to the vertical portion 522 perpendicular to the horizontal portion 521. Such butyl tape 530 should be ½″ by ⅛″ butyl tape (ADCO Formula #BX-035). However, it is important to note that this secondary adhesive can be any shape sufficient to effectuate a seal with the insert 100—including essentially rectangular strips of butyl tape 530. For example, multiple rectangular strips of butyl tape 530 could be placed within the horizontal portion 521 to help create a seal.

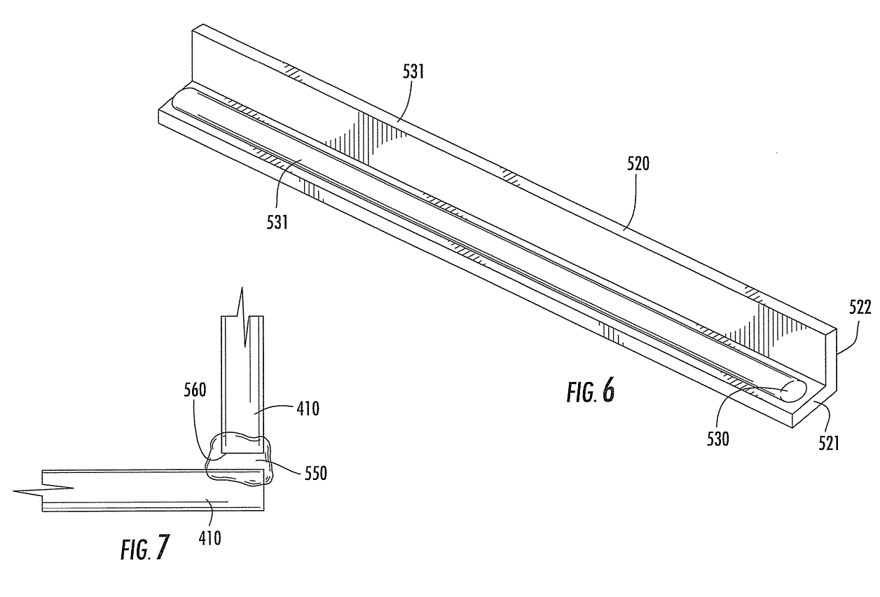

FIG. 7 offers a more detailed view of the placement of liquid based sealant 550.

### Method of Affixing an Insert

In addition to the aforementioned systems, the invention is further directed to a preferred method of attaching an insert onto an existing bathtub. FIG. 1 through FIG. 3 highlight the result of using this preferred method. The method begins with the step of creating a three-layer constructed frame around the upper flat portion 201 of the existing bathtub 200. First, a strip of essentially flat primer sheet 510 is placed on each side (including the upper edge 202, the lower edge 203, the right edge 204 and the left edge 205) of the upper flat portion 201. The affixed primer sheet 510 is preferably (but not necessarily) manufactured from Polyken 1027.

An essentially “L” shaped gasket 520, as illustrated in FIG. 2A, is then secured on top of the primer sheet 510. The “L” shaped gasket 520 is preferably made of synthetic rubber or butylene and includes a horizontal portion 521 and a vertical portion 522 (perpendicular to the horizontal portion 521). Alternatively, as shown in FIG. 2B, an essentially “U” shaped gasket 570 (preferably made of synthetic rubber or butylene) can be secured to the top of the primer sheet 510. The “U” shaped gasket 570 includes a pair of vertical portions 571 and 572 attached on top of (and perpendicular to) the essentially flat horizontal portion 521.

The horizontal portion 521 of either gasket 520 or 570 effectively creates a conduit 573. Attached within the conduit 573 is a strip of butyl tape 540, which is circular in cross section. It is preferable (but not necessary) to use ½″ by ⅛″ butyl tape (ADCO Formula #BX-035) as the butyl tape 540.

Upon affixing this three-part constructed frame along the upper flat portion 201, a concentration of liquid based sealant 550 is placed at each adjoining corner 560 of the frame. This liquid based sealant 550 is preferably a silicone based sealant whose composition is organopolysiloxane. However, any similar liquid based sealant 550 known to those of ordinary skill in the art can be used. Next, the insert 100 is positioned on top of the existing bathtub 200 and secured to created a non-permeable and durable seal through multiple sealing points 531 between the insert 100 (i.e., 520 and 540), the liquid based sealant 550, and the existing bathtub 200.

While the foregoing provide preferred embodiments for the systems and method, other embodiments will be known and understood by those of ordinary skill in the art.

I claim:

1. A refurbished bathtub system, comprising:
an existing bathtub having contours, a recess and an essentially flat upper portion;
an insert of sufficient size and dimension so as to mirror to the contours, recess and essentially flat upper portion of the existing bathtub;
a three-piece constructed frame placed on the essentially flat upper portion, said three-piece constructed frame including (a) an essentially flat primer sheet affixed directly to the upper flat portion of the existing bathtub, (b) a gasket having an essentially flat horizontal portion affixed to the primer sheet, and (c) at least one strip of adhesive tape affixed to the gasket; and
a concentration of liquid based sealant placed at each of the adjoining corners of the three-piece constructed frame.

2. The system of claim 1, wherein:
the gasket is essentially “L” shaped through attaching a vertical portion perpendicular to the essentially flat horizontal portion.

3. The system of claim 1, wherein:
the gasket is essentially “U” shaped through attaching two vertical portions parallel to one another and both perpendicular to the essentially flat horizontal portion.

4. The system of claim 1, wherein:
the gasket, including the one or more vertical portions, is made of synthetic rubber.

5. The system of claim 1, wherein:
the tape is butyl tape essentially circular in cross-section.

6. The system of claim 5, wherein:
the tape is ½″ by ⅛″ in cross section and manufactured from ADCO Formula #BX-035.

7. The system of claim 1, wherein:
the liquid based sealant is a silicone whose composition is organopolysiloxane.

8. A refurbished shower enclosure system, comprising:
an existing shower enclosure containing one or more sides, each said side having an upper edge, a lower edge, a right side edge and a left side edge;
one or more essentially flat panels, each said panel having a dimension which mirrors each respective side of the existing shower enclosure;
an outside frame constructed proximate to the upper edge, lower edge, right side edge and left side edge of each respective side of the existing shower enclosure;
said outside frame including a plurality of strips of adhesive tape essentially circular in cross section affixed on the existing shower enclosure; and
a concentration of liquid based sealant placed at each of the adjoining corners of the outside frame.

9. The system of claim 8, further comprising:
an existing window located on one side of the existing shower enclosure having an upper edge, a lower edge, a right side edge and a left side edge;
an inside frame constructed proximate to the upper edge, lower edge, right side edge and left side edge of the existing window;
said inside frame including a plurality of strips of tape essentially circular in cross section affixed on the existing shower enclosure; and
a concentration of liquid based sealant placed at each of the adjoining corners of the inside frame.

10. The system of claim 8, further comprising:
a number of protrusions located on one side of the existing shower enclosure;
a protrusion frame which includes two elongated vertical strips of sufficient length as to border all of the protrusions and multiple horizontal strips located directly above and below each protrusion; and
a concentration of liquid based sealant placed at each of the adjoining corners of the protrusion frame.

11. The system of claim 8 wherein:
the tape is butyl tape ½″ by ⅛″ in cross section and manufactured from ADCO Formula #BX-035.

12. The system of claim 8 wherein:
the liquid based sealant is a silicone whose composition is organopolysiloxane.

13. A method for refurbishing a bathtub through affixing an insert onto an existing bathtub having sides and an upper flat portion, comprising the steps of:
(a) affixing a strip of flat primer sheet directly on each side and the upper flat portion of the existing bathtub as the foundation of a frame;
(b) securing a gasket, having an essentially flat horizontal portion, on each strip of primer sheet in order to add a second layer to the frame;
(c) attaching a strip of adhesive tape onto the essentially flat horizontal portion of each gasket to create a third layer to the frame;
(d) placing a concentration of liquid based sealant at each of the adjoining corners of the three-layer frame;
(e) positioning the insert on top of the existing bathtub; and
(f) securing the insert to the existing bathtub.
(g)

14. The method of claim 13, wherein:
the insert is made of acrylic.

15. The method of claim 13, wherein:
the gasket is essentially “L” shaped through attaching a vertical portion perpendicular to the essentially flat horizontal portion.

16. The method of claim 13, wherein:
the gasket is essentially “U” shaped through attaching two vertical portions parallel to one another and both perpendicular to the essentially flat horizontal portion.

17. The method of claim 13, wherein:
the gasket is made of synthetic rubber.

18. The method of claim 13, wherein:
the tape is butyl tape essentially circular in cross-section.

19. The method of claim 13, wherein:
the tape is butyl tape ½″ by ⅛″ in cross section and manufactured from ADCO Formula #BX-035.

20. The method of claim 13, wherein:
the liquid based sealant is a silicone whose composition is organopolysiloxane.
